(19) United States
(12) Patent Application Publication
(10) Pub. No.: US 2024/0116117 A1
(43) Pub. Date: Apr. 11, 2024

(54) METHOD FOR RELEASING A DRILL CORE FROM A DRILL BIT OF A CORE DRILLING DEVICE AND CORE DRILLING DEVICE

(71) Applicant: Hilti Aktiengesellschaft, Schaan (LI)

(72) Inventors: Michael LACHER, Schwabmuenchen (DE); Stefan RINGLER, Schwabmuehlhausen (DE); Manel OUNI, Augsburg (DE); Roland SCHWAB, Geltendorf (DE)

(21) Appl. No.: 18/286,451

(22) PCT Filed: Apr. 12, 2022
(86) PCT No.: PCT/EP2022/059673

§ 371 Date: Oct. 11, 2023

(30) Foreign Application Priority Data
Apr. 26, 2021 (EP) 21170477.0

(51) Int. Cl. B23B 51/04

(52) U.S. Cl. CPC B23B 51/0453; B23B 51/04

(57) ABSTRACT

A method for releasing a drill core from a drill bit of a core drilling device, with an intuitive movement being recognized and used as a trigger for a shaking process for the drill core. The intuitive movement may be for example a shaking movement of the core drilling device. A core drilling device for carrying out the proposed method is also provided. The core drilling device preferably includes a sensor system for detecting the intuitive movement of the core drilling device, while the sensor system may for example comprise a gyro sensor.

The present invention relates to a method for releasing a drill core from a drill bit of a core drilling device.

### BACKGROUND OF THE INVENTION

Core drilling devices with which cylindrical drill cores can be cut out of solid substrates, such as concrete, masonry or stone, are known in the prior art. Core drilling devices have as a tool a substantially cylindrical drill bit, which is hollow on the inside to receive the drill core. The user of a core drilling device knows from experience that it can be a challenge to remove the drill core from the drill bit.

In the prior art, it is known for example to remove the drill core from the drill bit by mechanical means. To do this, the drill bit is separated from the core drilling device and an attempt is made to release the drill core from the drill bit by shaking or hammering and to remove it from the inside of the drill bit. This procedure can sometimes be very tedious and time-consuming. In addition, the drill bit can be damaged by the hammer blows and its service life can be shortened.

Other methods for releasing the drill core from the drill bit, which are referred to below as electronic methods for releasing the drill core from the drill bit, have therefore become known in the prior art. The drill bit remains on the core drilling device, with a shaking process being started on the core drilling device by actuating a switch provided specifically for this purpose. Such a process may be referred to in the sense of the invention as an electronic shaking process.

### SUMMARY OF THE INVENTION

However, it has been found that the provision of a separate switch for the electronic shaking function is complex to implement. In addition, the provision of such a switch is not desirable for reasons of space and it cannot be ensured that it would be ergonomically advisable for such a switch to be actuated by a user of the core drilling device. Furthermore, additional switches and operator control elements require additional space, which is contrary to the need for compact, handy power tools.

An object on which the present invention is based is to overcome the disadvantages of the prior art described above and to provide a method for releasing a drill core from a drill bit of a core drilling device that does not require an additional switch for the electronic shaking function of the core drilling device. In addition, those skilled in the art would appreciate it if the shaking function could be started as intuitively as possible without the user having to press complex key combinations or perform a manipulation. In addition, the core drilling device to be provided should be formed so as to be as compact and handy as possible.

According to the invention, a method for releasing a drill core from a drill bit of a core drilling device is provided. The method is characterized by the following steps of:
a) detecting an intuitive movement of the core drilling device by the core drilling device,
b) starting a shaking process for the drill core.

With the proposed method it is possible to provide a method for starting the electronic shaking function, preferably automatically, which does not require an additional switch for the electronic shaking function of the core drilling device. In addition, the method is particularly intuitive to carry out, since the user performs an intuitive movement with the core drilling device, which can be recognized by the core drilling device. For this purpose, the core drilling device preferably comprises a suitable sensor system, which has a gyro sensor for detecting the intuitive movement of the core drilling device. The sensor system may preferably be designed as a sensor unit, with the at least one gyro sensor of this sensor unit preferably being set up to detect an intuitive movement of the core drilling device. The intuitive movement may be for example a shaking movement of the core drilling device. In other words, it is preferred in the sense of the invention that the intuitive movement of the core drilling device comprises a shaking movement, it being possible for the detection of the intuitive movement to be used as a trigger or starting signal for a shaking process for the drill core. During the shaking movement, the core drilling device is essentially moved along the Z axis of an imaginary coordinate system (cf. FIG. 1), which is equivalent to a shaking movement. Such a shaking movement is known from the prior art for mechanically shaking the drill core out of the drill bit. However, the shaking movement may also comprise components of movements in all three spatial directions, as well as rotations about all three spatial axes. In the context of the present invention, the shaking movement known and familiar to the user is used as an intuitive movement in order to start or initiate the preferably electronic shaking process for shaking the drill core out of the drill bit. The shaking process then preferably starts automatically after the core drilling device or its sensor system has recognized an intuitive movement. The advantage for the user is that he can essentially maintain the same behavior for removing the drill core from the drill bit, specifically shaking the drilling device in order to release the drill core from the drill bit. However, in the context of the present invention it is sufficient to perform the shaking movement less vigorously. Rather, it may be sufficient to merely suggest the intuitive shaking movement or only perform it to such an extent that it can be recognized by the core drilling device or its sensor system, i.e. in particular the gyro sensor. The user advantageously recognizes whether his intuitive movement was recognized as such by the core drilling device when the core drilling device begins to make the motor vibrate with current and the core drilling device starts the known electronic shaking process (Mechatronic Torque Control, MTC). During this shaking process, a strong torque is preferably generated in alternating directions, with the generated torque being greater than the static frictional moment between the drill bit and the drill core. The drill core is loosened by the torque and can be released or removed from the drill bit.

It is preferred in the sense of the invention that the core drilling device comprises a motor, with the core drilling device being set up to make the motor vibrate with current.

It is also preferred in the sense of the invention that the shaking process represents an electronic function that can for example already be implemented in the core drilling device. Unlike in the case of conventional core drilling devices, as are known from the prior art, it is not necessary in the context of the present invention to start the shaking process with a button or switch provided specifically for this purpose. Rather, in the context of the present invention, use is made of the ability of the core drilling device to recognize and evaluate movements that are performed by or act on it and to use them to control or initiate individual functions. A sensor system comprising at least one gyro sensor is preferably used for detecting these movements, which are referred to in the context of the invention as “intuitive movements”. In other words, it is preferred in the sense of the invention that the intuitive movement of the core drilling device is detected by a sensor system comprising at least one gyro sensor. The at least one gyro sensor may also be used for example for other functionalities or for starting them. For example, the Active Torque Control (ATC) function may be based on the data from the gyro sensor.

The gyro sensor is preferably set up to detect data relating to the movement of the core drilling device in all three spatial directions. In particular, rotations about all three spatial axes X, Y and Z can in this way be detected. The rotation data preferably determined by the gyro sensor with regard to the X, Y and/or Z axis can be advantageously used for recognizing an intuitive movement of the core drilling device by the user. An exemplary coordinate system formed from the three spatial axes X, Y and Z is shown in FIG. 1. Since preferably movements in all three spatial directions can be recognized by the core drilling device as intuitive movements in the sense of the invention, there is great flexibility and freedom in the selection and definition of the desired intuitive movement. In the sense of the invention, the intuitive movement may preferably also be referred to as an “agreed device movement” or a “significant movement”.

It is preferred in the sense of the invention that the sensor system of the core drilling device is set up to detect in particular the “rotating movement components” of an intuitive movement of the core drilling device. In the sense of the invention, these are preferably those movement components that relate to a rotation about the three spatial axes X, Y and Z (see FIG. 1). It is preferred in the sense of the invention that the intuitive movement may comprise linear and/or rotating movement components. The linear movement components preferably correspond to movements along the spatial axes or essentially parallel to them. The core drilling device or its sensor system is preferably set up to recognize both linear and rotating movement components of an intuitive movement. The inventors have recognized that, when the core drilling device is shaken by a user, it does not perform a strictly linear movement, as would be expected for example from a rigid, mechanical test setup. In the context of the present invention, it has been recognized in particular that the curved or rotating components of the shaking movement of the core drilling device can be recognized particularly well by a gyro sensor, so that it is preferred in the sense of the invention that the sensor system of the core drilling device has at least one gyro sensor for the detection of, in particular, the curved movement components of the intuitive movement of the core drilling device.

In a preferred embodiment of the invention, it may be provided that the core drilling device is started by a further action by the user between the detection of the intuitive movement and the start of the shaking process. In other words, this embodiment may include an additional method step in which the user carries out in addition to the intuitive movement an action referred to in the sense of the invention as a “further action” in order to start the core drilling device.

It is preferred in the sense of the invention that the core drilling device is ready for operation while it is being shaken. This preferably means in the sense of the invention that its device electronics and its sensor system are active. However, the motor of the core drilling device is preferably not running during the shaking process. Also, the trigger is not actuated during the shaking. It is preferred in the sense of the invention that the trigger is pressed after the shaking, as a result of which the core drilling device starts the shaking process. The shaking process is preferably started in particular by the motor of the core drilling device. The trigger can then be let go again, which advantageously stops the motor from running.

The further action of the user of the core drilling device may be for example the user actuating an on switch of the core drilling device. In other words, the method in this preferred embodiment comprises the additional method step that the core drilling device is switched on by the user, with this switching on of the core drilling device preferably being performed by actuating the on switch of the core drilling device. The on switch of the core drilling device may preferably also be referred to in the sense of the invention as a “trigger” or a “switch device”.

It is preferred in the sense of the invention that, to start the preferably electronic shaking process for releasing the drill core from the drill bit, in the context of the present invention, depending on the embodiment, a maximum of two actions by the user are required, specifically the performance of an intuitive movement with the core drilling device and optionally another action, which may for example be that of actuating the trigger of the core drilling device. The activation of the shaking process, which is preferably of an electronic form, can thus be made significantly easier and more intuitive with the present invention than with conventional core drilling devices such as are known from the prior art. Advantageously, the handling of the proposed core drilling device can in this way be made significantly easier compared to conventional core drilling devices. In addition, the construction of the core drilling device does not require an additional switch for switching on the preferably electronic shaking process, since such a switch is no longer required due to the advantageous interaction of the intuitive movement and its recognition by the core drilling device, as is the subject of the present invention. By obviating the need for an additional switch, the invention makes it possible to provide a particularly compact, handy core drilling device that is easier to handle.

It is preferred in the sense of the invention that the shaking process is ended by a second action by the user of the core drilling device. This preferably means in the sense of the invention that the preferably electronic shaking process for releasing the drill core from the drill bit can be ended by the user performing a second action. This may be the same action as when switching on the shaking process. However, it may also be preferred in the sense of the invention that the switching on of the shaking process and the switching off of the shaking process are brought about by different actions by the user. In the first case, in which the further action and the second action are the same, the switching on and off may respectively take place for example by actuating the on switch of the core drilling device. In the second case, in which the further action and the second action are not the same, the switching on of the shaking process may for example take place by actuating the on switch of the core drilling device, while the switching off is brought about by another action, such as letting go the on switch of the core drilling device. It is particularly preferred in the sense of the invention that the shaking process is switched off by letting go the trigger of the core drilling device. Switching off the shaking process is preferably also referred to in the sense of the invention as deactivation of the shaking process. In this case, the core drilling device preferably ends the vibrating of the motor of the core drilling device with current, so that the shaking movement for releasing the drill core from the drill bit stops.

It is preferred in the sense of the invention that the shaking process is brought about by making a motor of the core drilling device vibrate with current. This means that the shaking process consists in particular in that the motor of the core drilling device is made to vibrate with current.

In a second aspect, the invention relates to a core drilling device for carrying out the proposed method. The terms, definitions and technical advantages introduced for the method for releasing a drill core from a drill bit preferably apply analogously to the core drilling device. It is particularly preferred in the sense of the invention that the core drilling device comprises a sensor system comprising at least one gyro sensor. The gyro sensor is set up in particular to detect movements of the core drilling device and to provide the basis for recognizing a specific movement of the core drilling device or a specific movement pattern as an “intuitive movement” in the sense of the invention. For this purpose, exemplary movements and/or movement patterns that are associated with an “intuitive movement” may be stored in the core drilling device, with the core drilling device being able to determine whether or not there is an “intuitive movement” in the sense of the invention by comparing the movements and/or movement patterns detected by the sensor system with the stored movements and/or movement patterns. These processes or evaluations may proceed for example in a control device of the core drilling device. If an “intuitive movement” of the core drilling device is recognized by the core drilling device or its sensor system, the preferably electronic shaking process of the core drilling device is preferably started automatically and the drill core is thus removed from the drill bit. It is preferred in the sense of the invention that the core drilling device comprises a control device which is set up to recognize an intuitive movement of the core drilling device and to start the shaking process as a reaction to the recognition of the intuitive movement.

It is most particularly preferred in the sense of the invention that the core drilling device does not require an additional switch for activating the shaking process. As described, it is possible to dispense with a switch specifically intended for starting the shaking process since, according to the invention, the shaking process is started by recognizing an intuitive movement of the core drilling device. In other words, preferably sensors that are already present or data that has already been collected elsewhere, for example rotation data, can be better utilized by the invention and used to control other functions, such as for example the shaking process.

Advantages of the invention are, in particular, that a particularly intuitive activation of the shaking process for releasing a drill core from a drill bit can be provided.

In addition, easy, intuitive and clear operation of the core drilling device is made possible, which in particular manages with a comparatively small number of switches. As a result, in particular the production costs for the core drilling device can also be kept low and a space-saving, compact core drilling device can be provided. This can be of particular advantage in particular when a hand-held core drilling device is to be provided rather than a stand-mounted core drilling device.

In one exemplary embodiment, the present invention relates to a method for removing a drill core from a drill bit of a core drilling device. In this case, first a core drilling device with a drill bit is provided, it being possible for the drill bit to contain a drill core from a previously performed core drilling. The core drilling device comprises a sensor unit for recognizing an agreed device movement for removing the drill core from the drill bit, with the agreed device movement being performed by the user of the core drilling device with the core drilling device. If the user additionally actuates a switch device of the core drilling device while performing the device movement, a mechanical process for removing the drill core from the drill bit can be started by the core drilling device.

Further advantages will become apparent from the following description of the figures. The FIGURE, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the FIGURE, specifically:

FIG. 1 shows a view of an exemplary preferred embodiment of the invention.

### DETAILED DESCRIPTION

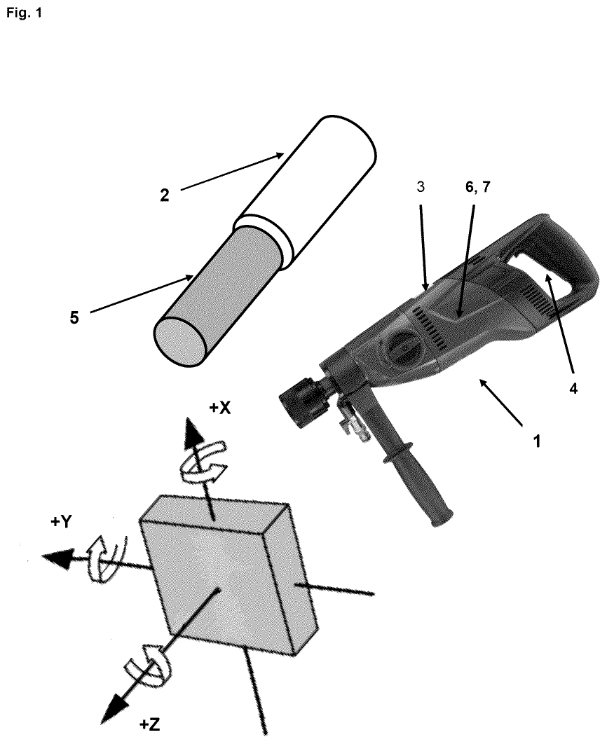

FIG. 1 shows a possible embodiment of the invention. In particular, FIG. 1 shows a core drilling device 1 for cutting out drill cores 5 from a hard substrate, such as concrete, stone or masonry. The tool of the core drilling device 1 is a drill bit 2, in which the drill core 5 is received during the cutting process. The drill bit 2 and the drill core 5 are schematically indicated at the top left in FIG. 1. In the context of the proposed invention, a method for releasing such a drill core 5 from the drill bit 2 of a core drilling device 1 is proposed. For this purpose, the core drilling device 1 can be shaken by a user, it being possible for this shaking movement to be recognized by the core drilling device 1 as an “intuitive movement” in the sense of the invention. The core drilling device 1 can use the intuitive movement as a starting signal for a preferably electronic shaking process, which may be implemented in the core drilling device 1. In order to recognize the intuitive movement of the core drilling device 1, the core drilling device 1 may include a sensor system 3, which in particular comprises a gyro sensor 3a. Furthermore, the core drilling device 1 may comprise a control device 7 and a motor 6. The motor 6 of the core drilling device 1 is set up in particular to be subjected to a vibrating current, which advantageously leads to the preferably electronic shaking process for the drill core 5. The core drilling device 1 may also have a switch 4, with which the core drilling device 1 can be activated or switched on by a user. The sensor 3 may for example be arranged in spatial proximity to the electronics of the core drilling device 1.

It is preferred in the sense of the invention that the core drilling device 1 does not require an additional switch for activating the shaking process. The control device 7 of the core drilling device 1 is preferably set up to recognize an intuitive movement of the core drilling device 1 and to start the shaking process—preferably automatically—as a reaction to the recognition of the intuitive movement. The intuitive movement of the core drilling device 1 may be in particular a shaking movement along the Z axis of an imaginary coordinate system, which is shown in the lower region of FIG. 1. In particular, also shown in FIG. 1 are possible rotational movements around the three spatial axes X, Y and Z which can be performed by the core drilling device 1 and recognized by the sensor system 3 of the core drilling device 1 as an intuitive movement.

In one exemplary embodiment, the invention relates to a method for removing a drill core 5 from a drill bit 2 of a core drilling device 1, wherein the method can be characterized by the following method steps:
a) providing a core drilling device 1 with a drill bit 2, with the drill bit 2 containing a drill core 5 from a previously performed core drilling,
b) recognizing an agreed device movement for removing the drill core 5 from the drill bit 2 by a sensor unit 3, with the agreed device movement being performed by the user of the core drilling device 1 with the core drilling device 1,
c) actuating a switch device 4 of the core drilling device 1 by the user,
d) starting a process for removing the drill core 5 from the drill bit 2 by the core drilling device 1.

The agreed device movement can preferably also be referred to in the sense of the invention as an intuitive movement of the core drilling device 1. The terms switch device, on switch or trigger are used synonymously in the context of the present invention and are denoted by the reference numeral 4. The position of the on switch 4, as it is shown in FIG. 1, is to be understood as an example, with many other positions on the core drilling device 1 being conceivable and possible.

It is preferred in the sense of the invention that the shaking process for removing the drill core 5 from the drill bit 2 is ended when the actuation of the switch device 4 by the user is ended. The core drilling device 1 preferably has a sensor unit 3 for recognizing an intuitive movement of the core drilling device 1, it being possible for this intuitive movement to be performed by the user of the core drilling device 1 with the core drilling device 1. It is preferred in the sense of the invention that the sensor unit 3 comprises a gyro sensor 3a.

### LIST OF REFERENCE NUMERALS

1 Core drilling device
2 Drill bit
3 Sensor system
3a: Gyro sensor
4 On switch
5 Drill core
6 Motor of the core drilling device
7 Control device of the core drilling device

What is claimed is:

1-13. (canceled)

14. A method for releasing a drill core from a drill bit of a core drill, the method comprising the following steps:
a) detecting an intuitive movement of the core drill by the core drill; and
b) starting a shaking process for the drill core.

15. The method as recited in claim 14 wherein between method steps a) and b), the core drill is started by a further action by a user of the core drill.

16. The method as recited in claim 14 wherein the shaking process is ended by a second action by the user of the core drill.

17. The method as recited in claim 14 wherein the shaking process is an electronic function which is implemented in the core drill.

18. The method as recited in claim 14 wherein the shaking process is brought about by making a motor of the core drill vibrate with current.

19. The method as recited in claim 14 wherein the intuitive movement of the core drill is detected by a sensor.

20. The method as recited in claim 19 wherein the sensor includes at least one gyro sensor.

21. The method as recited in claim 14 wherein the intuitive movement of the core drill includes a shaking movement.

22. A core drill for carrying out the method as recited in claim 14, the core drill comprising a sensor for detecting an intuitive movement of the core drilling device.

23. The core drill as recited in claim 22 wherein the sensor includes at least one gyro sensor.

24. The core drill as recited in claim 22 wherein the core drill does not require an additional switch for activating the shaking process.

25. The core drill as recited in claim 22 further comprising a controller set up to recognize an intuitive movement of the core drilling device and to start the shaking process as a reaction to the recognition of the intuitive movement.

26. The core drill as recited in claim 22 further comprising a motor, the core drill set up to make the motor vibrate with current.
